(19) United States
(12) Patent Application Publication
(10) Pub. No.: US 2011/0241378 A1
(43) Pub. Date: Oct. 6, 2011

(54) FRONT-END STRUCTURE FOR A MOTOR VEHICLE

(75) Inventor: Claus STELLER, Gross-Gerau (DE)

(73) Assignee: GM GLOBAL TECHNOLOGY OPERATIONS LLC, Detroit, MI (US)

(21) Appl. No.: 13/073,063

(22) Filed: Mar. 28, 2011

(30) Foreign Application Priority Data
Mar. 30, 2010 (DE) 102010013381.7

(51) Int. Cl. B62D 25/08

(52) U.S. Cl. 296/187.09; 296/193.09

(57) ABSTRACT

With a front-end structure for a motor vehicle, a radiator of a combustion engine and a condenser of an air conditioner are arranged vertically on top of each other. Here, the radiator has the substantially square shape of a block charge air cooler and is located below an edge of the combustion engine facing in driving direction.

### CROSS-REFERENCE TO RELATED APPLICATION

This application claims priority to German Patent Application No. 102010013381.7, filed Mar. 30, 2010, which is incorporated herein by reference in its entirety.

### TECHNICAL FIELD

The technical field relates to a front-end structure for a motor vehicle with a condenser for an air conditioner arranged at an end facing in driving direction and with a radiator for a combustion engine of the motor vehicle.

### BACKGROUND

Front-end structures are frequently employed with today's motor vehicles and are known from practice. The condenser for the air conditioner and the radiator for the combustion engine form a constructional unit with the known front-end structures. A constructional unit of condenser for the air conditioner and radiator for the combustion engine is known for example from DE 689 05 753 T2. With this constructional unit the condenser and the radiator are arranged one after the other seen in driving direction and in each case designed plate-shaped transversely to the driving direction. The constructional unit can be directly installed behind a radiator grille of the front-end structure facing in driving direction.

Disadvantageous with the known front-end structures is that the arrangement of the radiator in driving direction behind the condenser leads to an impairment of the cooling capacity of both components. For example the radiator receives air preheated by the condenser. The radiator and the condenser additionally throttle the headwind as a result of which the cooling capacity drops further. In practice one makes do with designing the radiator and the condenser of the known front-end structure with a particularly large surface in order to counteract the low cooling capacity. The large surface design of the radiator and the condenser however results in a large space requirement, a large weight and high manufacturing costs of these components.

In view of the foregoing, at least one object is to design a front-end structure of the type mentioned at the outset so that it makes possible a particularly high cooling capacity of the condenser and of the radiator. In addition, other objects, desirable features and characteristics will become apparent from the subsequent summary and detailed description, and the appended claims, taken in conjunction with the accompanying drawings and this background.

### SUMMARY

This problem is solved in that the radiator and the condenser are arranged vertically on top of each other. Through this configuration an impairment of the heat removal on the condenser through the backup of cooling air on the radiator is avoided. This leads to an improvement of the cooling capacity of the radiator of the combustion engine and of the condenser of the air conditioner since both components are exposed to fresh cool headwind. This configuration improves the efficiency of the radiator of the combustion engine and of the condenser of the air conditioner so that both components can be produced particularly small, light and cost-effectively.

Mostly the temperature in the fluid of the air conditioner is lower than the temperature of the cooling medium in the radiator. With such motor vehicles a particularly low temperature of the fluid of the air conditioner can be ensured according to an advantageous further development of the invention if the radiator is arranged below the condenser.

Motor vehicles with a turbocharger comprise a block charge air cooler of compact design. With motor vehicles without turbocharger the installation space for the block charge air cooler available anyhow can be simply utilized according to another embodiment if the radiator has the shape of a block charge air cooler or block shape cooler. Such coolers have a particularly compact design and are characterized by an approximately square cross section. More preferably if the installation space for the block charge air cooler or block shape cooler and thus according to the invention the radiator of the combustion engine is arranged below the condenser of the air conditioner, the front-end structure has a particularly low centre of gravity.

According to an embodiment, the front-end structure makes possible a particularly high crash safety if the radiator of the combustion engine is arranged below an edge of an engine block comprising the combustion engine facing in driving direction. Through this configuration the part of the engine block facing in driving direction stands exclusively opposite the condenser of the air conditioner. Thus, a large spacing to the next component is located immediately in front of the engine block as a result of which the front-end structure according to the invention comprises a large deformation path.

In the event of a crash of the motor vehicle comprising the front-end structure the impact energy according to an embodiment can be absorbed if at the height of the condenser and in front of the condenser an impact limiter is arranged. The impact limiter absorbs impact energy through its own deformation. A further advantage of this configuration is that during a crash only the condenser and not the radiator of the combustion engine is damaged. Thus the motor vehicle remains in a drivable state. Repair costs are additionally kept low as a result. In addition, a free space is left between the impact limiter and the condenser which is so dimensioned that the impact limiter in the case of slight collisions can be deformed into said free space without contacting and damaging the condenser.

### BRIEF DESCRIPTION OF THE DRAWINGS

The present invention will hereinafter be described in conjunction with the following drawing figures, wherein like numerals denote like elements, and:

FIG. 1 is a motor vehicle from the side with a front-end structure according to an embodiment;

FIG. 2 is schematically a longitudinal section through the front-end structure from FIG. 1;

FIGS. 3a and 3b are schematically a front-end structure according to the prior art before and after a crash; and

FIGS. 4a and 4b are a front-end structure according to an embodiment before and after a crash.

### DETAILED DESCRIPTION

The following detailed description is merely exemplary in nature and is not intended to limit application and uses. Furthermore, there is no intention to be bound by any theory presented in the preceding background or summary or the following detailed description.

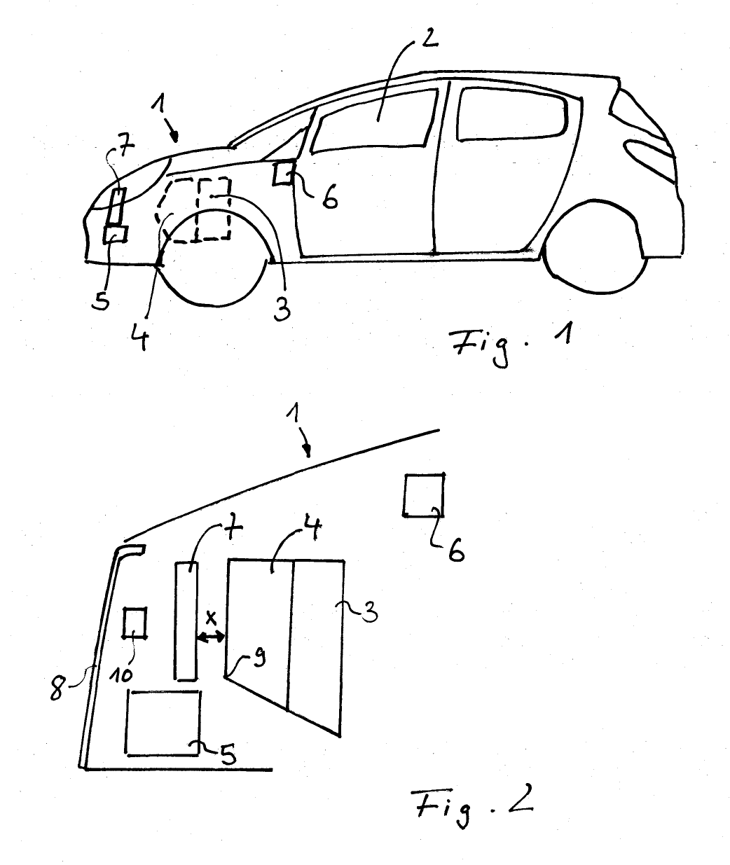

FIG. 1 shows a motor vehicle with a front-end structure 1 facing in driving direction and a passenger cell 2 arranged behind the front-end structure 1. In the front-end structure 1 an engine block 3 with a combustion engine 4, as well as a radiator 5 for the combustion engine 4 are arranged. In addition, the motor vehicle has an air conditioner 6 for the passenger cell 2. A condenser 7 of the air conditioner 6 is arranged in the end of the front-end structure 1 facing in driving direction.

FIG. 2, in a longitudinal section through the front-end structure 1 from FIG. 1, shows that the front-end structure 1 is delimited in driving direction by a radiator grille 8. Immediately behind the radiator grille 8 the radiator 5 of the combustion engine 4 and the condenser 7 of the air conditioner 6 are arranged vertically on top of each other. The condenser 7 is designed plate-shaped and arranged above the radiator 5. The radiator 5 has a substantially square cross section and thus the shape of a block charge air cooler. The radiator 5 is arranged below an edge 9 of the engine block 3 facing in driving direction.

In front of the condenser 7 an impact limiter 10 or cross member is arranged. The impact limiter 10 is deformed during a crash and thus removes impact energy. The deformation path of the impact limiter 10 prior to contact with the condenser 7 is marked with an “x”.

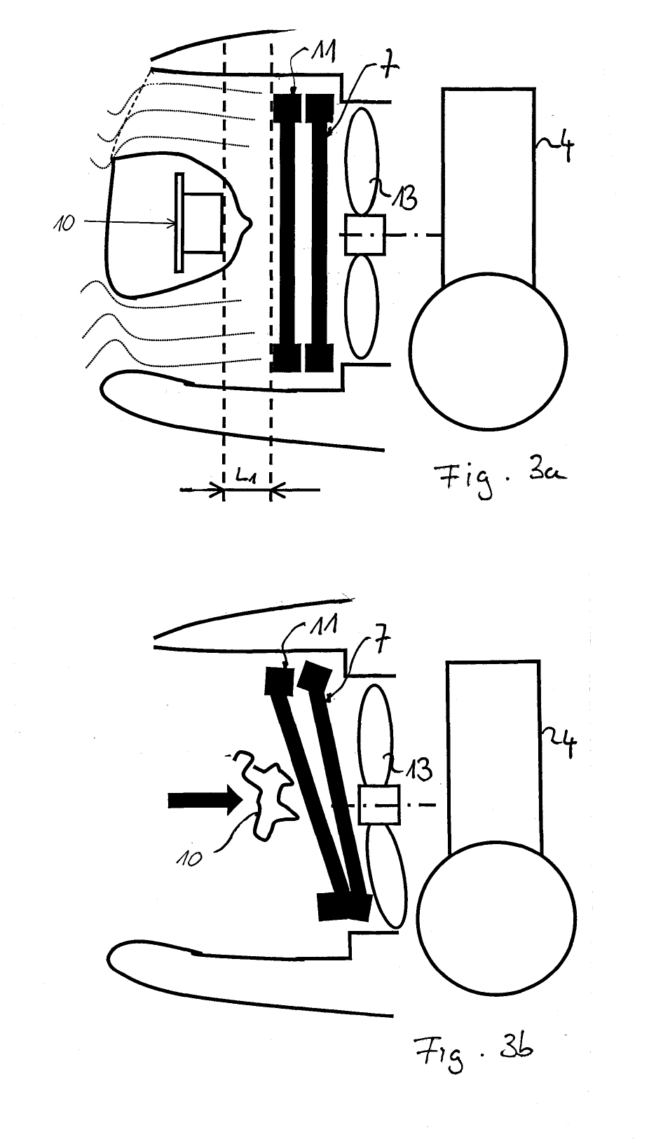

FIG. 3a and FIG. 3b show a front-end structure according to the prior art before and after a crash. A flat plate-type radiator 11 of the combustion engine 4 is arranged in front of the condenser 7 of the air conditioner. The plate-type radiator 11 in the basic state has a spacing L1 to the impact limiter 10. The impact limiter 10 arranged in front of the plate-type radiator 11 is deformed in the event of a crash and presses against the plate-type radiator 11. The plate-type radiator 11 displaces the condenser 7 against a blower 13. Thus during the crash both the plate-type radiator 11 as well as the condenser 7 are damaged. The combustion engine 4 is no longer cooled as a result and can thus be no longer operated.

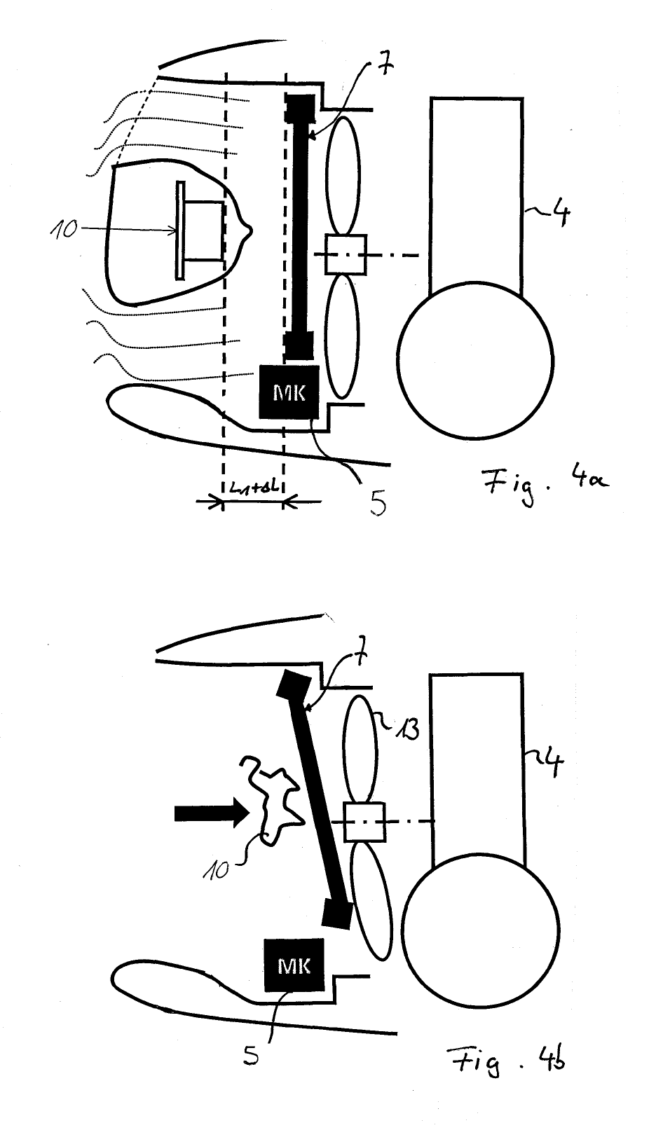

FIG. 4a and FIG. 4b show the front-end structure according to the invention before and after a crash. A radiator 5 of the combustion engine having a substantially square cross section and thus the shape of a block charge air cooler is arranged below the condenser 7 of the air conditioner. Thus the spacing between condenser 7 and impact limiter 10 in the basic state is larger by the amount ΔL than with the prior art according to FIG. 3a. During the crash the impact limiter 10 can be deformed by the amount L1 plus ΔL before it comes up against the condenser 7. The radiator 5 of the combustion engine 4 remains undamaged in the process so that continued operation of the combustion engine 4 remains possible. A comparison of the FIG. 3a and FIG. 4a shows that through the arrangement of the radiator of the combustion engine 4 below the condenser 7 the space between condenser 7 and impact limiter 10 is enlarged by the amount ΔL.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A front-end structure for a motor vehicle, comprising:
a condenser configured as an air conditioner arranged at an end facing in a driving direction; and
a radiator for a combustion engine arranged vertically with respect to the condenser.

2. The front-end structure according to claim 1, wherein the radiator is arranged vertically below the condenser.

3. The front-end structure according to claim 1, wherein the radiator is arranged vertically above the condenser.

4. The front-end structure according to claim 1, wherein the radiator has a shape of a block charge air cooler.

5. The front-end structure according to claim 1, wherein the radiator has a shape of a block shape cooler.

6. The front-end structure according to claim 1, wherein the radiator of the combustion engine is arranged below an edge facing in the driving direction of an engine block comprising the combustion engine.

7. The front-end structure according to claim 6, further comprising an impact limiter arranged at a height of the condenser .

8. The front-end structure according to claim 7, wherein a free space is exists between the condenser and the impact limiter that serves as deformation path for the impact limiter.
